(19) United States
(12) Patent Application Publication
(10) Pub. No.: US 2009/0115266 A1
(43) Pub. Date: May 7, 2009

(54) POWER TOOL WITH FRAMELESS MOTOR AND TWO-PIECE BRUSH ASSEMBLY, AND METHOD OF ASSEMBLY

(75) Inventors: Eric Hatfield, Jacobus, PA (US); David J. Smith, Eldersburg, MD (US)

Correspondence Address: Harness Dickey & Pierce, P.L.C., P.O. Box 828, Bloomfield Hills, MI, 48303, US

(73) Assignee: Black and Decker Inc.

(21) Appl. No.: 12/255,735

(22) Filed: Oct. 22, 2008

Related U.S. Application Data
(60) Provisional application No. 61/001,876, filed on Nov. 5, 2007.

(51) Int. Cl. H02K 7/14; H01R 39/38; H02K 15/14

(52) U.S. Cl. 310/50; 310/239; 29/596

(57) ABSTRACT

A power tool includes a tool housing and a motor. The motor includes a commutator and a brush assembly around the commutator. The brush assembly has two pieces. The power tool is assembled by inserting the first piece of the brush assembly in a first portion of the housing of the power tool, inserting a frameless motor in the first portion of the power tool housing, mating the second piece of the brush assembly to the first piece, and mating a second portion of the power tool housing to the first portion of the power tool housing.

### CROSS-REFERENCE TO RELATED APPLICATIONS

This application claims the benefit of U.S. Provisional Application No. 60/001,876, filed on Nov. 5, 2007. The entire disclosure of the above application is incorporated herein by reference.

### FIELD

The present disclosure relates generally to power tools and more particularly to power tools and brush assemblies in the electric motors in the power tools and their related assembly methods.

### BACKGROUND

The statements in this section merely provide background information related to the present disclosure and may not constitute prior art.

Known portable power tools typically have an electric motor received within a housing. One common type of electric motor used in power tools has a rotor, a stator, and brushes. The rotor includes a rotor shaft, laminations mounted on the rotor shaft, armature windings wound in slots in the lamination stack, and a commutator mounted on the rotor shaft and electrically connected to the armature windings. The stator may have field windings wound in laminations, or may have permanent magnets. The brushes are mounted in brush housings, often known as brush boxes, surrounding the commutator. Electric current is supplied from a power source through the brushes to the commutator and then to the armature windings.

The brushes and brush boxes are typically part of a brush assembly(ies). The brush boxes and brushes are disposed diametrically opposite to each other with the commutator disposed therebetween. The brush assembly(ies) includes springs that urge the brushes against the commutator.

One piece brush assemblies, sometimes referred to as brush cards, are sometimes used in power tools having frameless motors. In a frameless motor, the stator and rotor of the motor are not mounted in a frame. Rather, the power tool housing includes portions that receive the stator and also has bearing holders that receive the front and rear bearings through which the shaft of the rotor is entrained. The power tool housing in effect serves as the frame of the motor.

In one piece brush assemblies, the brushes, brush boxes and springs are pre-assembled, such as on a base member of the brush assembly, before the commutator is inserted through the brush assembly. The base member includes a central opening through which the commutator is inserted. This can present difficulties. In a first method, the springs are “parked” so they are not applying force to the brushes. Because the springs are not urging the brushes inwardly, it is relatively easy to insert the commutator in the central opening. It is, however, difficult to release the springs from the parked position so that they apply force to the brushes after the commutator is inserted through the central opening of the brush assembly due to lack of room to access the brush springs.

In a second method, the brush springs are positioned in a position where the springs urge the brushes inwardly. To insert the commutator through the brush assembly, the brushes must be pushed outwardly away from the central opening of the base member against the biasing force of the springs, such as by use of an external means, to allow enough room for insertion of the commutator. After the commutator is inserted, the springs are released so that they can urge the brushes against the commutator. Using an external means to push the brushes outwardly, however, can cause damage to the brushes.

In either method, because the commutator is inserted into the central opening brush assembly in a direction perpendicular to the travel direction of the brushes when the brushes are urged inwardly by the springs, the edges of the brush boxes or brushes may contact the surface of the commutator, possibly damaging it. Also, with the conventional one-piece brush assembly described above it is the difficult to access the brushes and commutator for service and replacement after the brush holder and the brushes are assembled.

### SUMMARY

In accordance with an aspect of the present disclosure, a power tool has a housing in which a frameless electric motor is received. A brush assembly is disposed in the housing. The brush assembly includes first and second separate pieces, each piece having a base member. Each base member has retention features that mate with the retention features of the other base member with the coactions of the retention features holding the base members together. A brush box is affixed to each base member and a brush received in each brush box. A spring is affixed to each base member and urges the brush received in the brush box of that base member inwardly against the commutator once the brush assembly and electric motor are fully assembled in the device using it, such as a power tool.

In accordance with an aspect of the present disclosure, a power tool has a housing having two housing halves. During assembly of the power tool, a first one of the separate portions of the brush assembly is placed into a first one of the two housing halves of the power tool. The frameless electric motor is then placed into this housing half of the power tool with a commutator adjacent the brush of the first one of the separate portions of the brush assembly. The other portion of the brush assembly is then mated to the first portion of the brush assembly. The other housing half of the power tool is then mated to the first housing half.

In accordance with an aspect of the present disclosure, a power tool has a housing in which a frameless electric motor is received. A brush assembly is disposed in the housing. The brush assembly includes first and second separate pieces received in a groove in the tool housing defined by opposed members. The first piece has a base member having opposed sides with a recess therein at ends of the opposed sides. The recess has a detent extending upwardly from a bottom surface. The second piece has opposed legs with each leg having a detent extending upwardly at an end. The opposed members that define the groove are spaced so that the detents of the base members of the first and second pieces snap together and are held snapped together by the opposed members to secure the first and second pieces together. Each of the first and second pieces has a brush box affixed to their respective base members, a brush received in the brush box and a spring that urges the brush against the commutator.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 illustrates a side cross-sectional view of a power tool having a two-piece brush assembly in accordance with an aspect of the present disclosure;

FIG. 2 illustrates one piece of the two-piece brush assembly of FIG. 1; and

FIGS. 3, 4 and 5 illustrate sequential steps of assembling a power tool with the two-piece brush assembly of FIG. 1 in accordance with an aspect of the present disclosure;

FIGS. 6A and 6B illustrate another embodiment of a two-piece brush assembly in accordance with an aspect of the present disclosure showing; and

FIGS. 7 & 8 illustrate sequential steps of assembling a power tool with the two-piece brush assembly of FIGS. 6A and 6B in accordance with an aspect of the present disclosure; and

FIG. 9 illustrates the two-piece brush assembly of FIGS. 6A and 6B.

### DETAILED DESCRIPTION

The following description is merely exemplary in nature and is not intended to limit the present disclosure, application, or uses. Corresponding reference numerals indicate corresponding parts throughout the several views of the drawings.

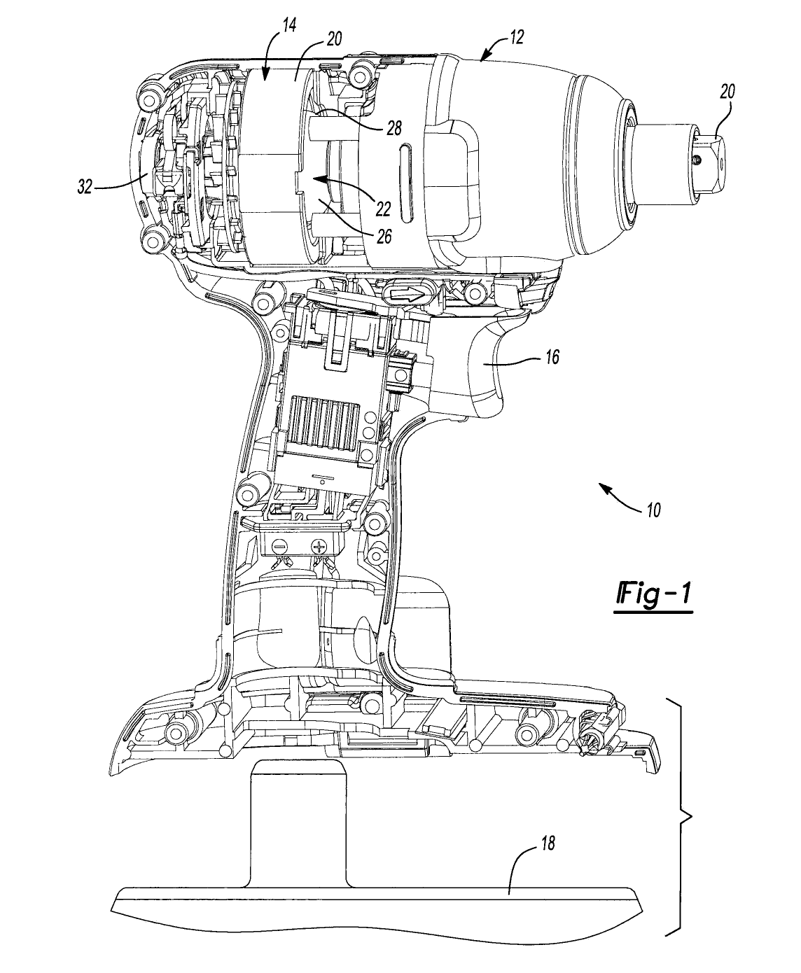

Referring to FIG. 1, a power tool in accordance with the present invention is illustrated and designated with the reference numeral 10. The power tool 10 is illustrated as an impact driver; however, any type of power tool may be used with the brush assembly of the present disclosure. The power tool 10 includes a housing 12 which surrounds a motor 14. The motor 14 is a frameless motor because it does not have a frame or housing enclosing the stator assembly and rotor. An activation member 16 is coupled with the motor 14 as well as with a power source 18. The power source 18 may be a battery (DC current) or a power cord (AC current) (not shown). The motor 14 is coupled with an output 20 to retain a tool (not shown), such as a socket.

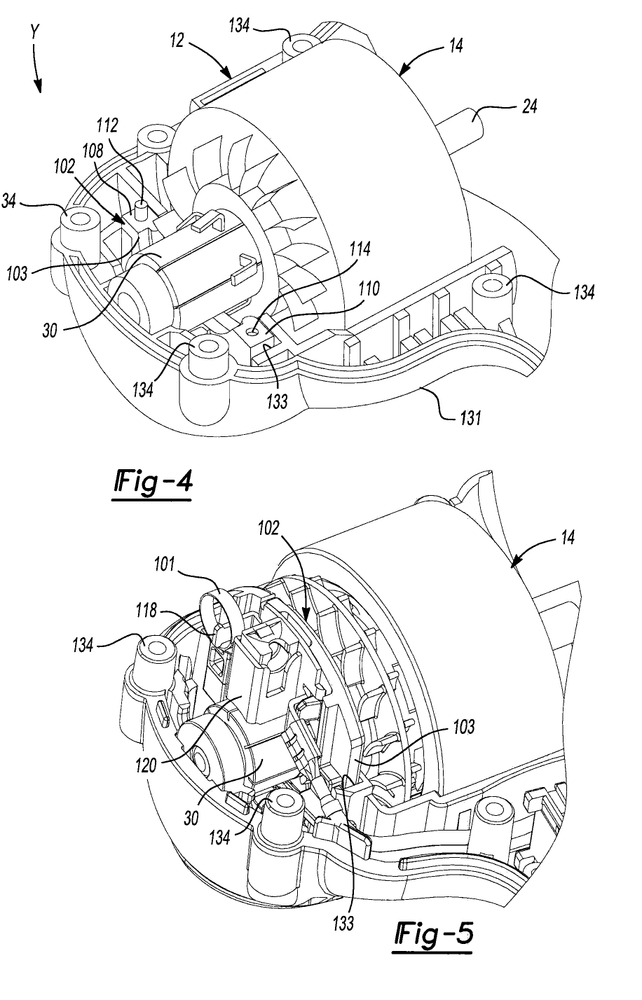

The motor 14 is illustratively a permanent magnet motor having a stator assembly 20 having magnets (not shown) surround an armature 22, which is also the rotor of motor 14. Armature 22, which is also the rotor of motor 14, includes a shaft 24 (FIGS. 4 & 8) on which laminations 26 are affixed and windings 28 wound in slots (not shown) in laminations 46, as well as a commutator 30 (FIGS. 4 & 8) affixed on the shaft 24. A front bearing (not shown) and rear bearing 32 for supporting opposing ends of the shaft 42 are received in tool housing 12. While motor 14 is shown as a permanent magnet motor, it should be understood that motor 14 could be a motor such as a universal series motor in which the stator includes laminations in which field windings are wound.

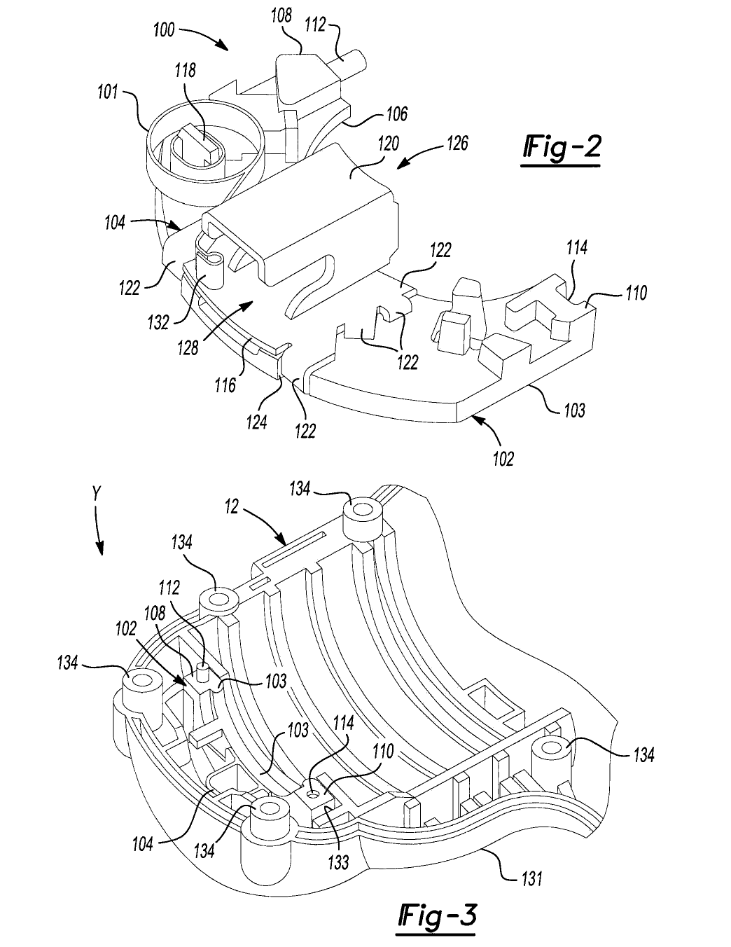

With reference to FIG. 2, a brush assembly 100 in accordance with an aspect of the present disclosure includes first and second pieces 102 on opposed sides of commutator 30. Each piece 102 of brush assembly 100 includes a base member 103 on which a brush box 104 is mounted. The base members 103 can be substantially identical or different, depending on applications. In an aspect, the base members 103 each have a substantially semi-annular inner periphery 106. In should be understood that the inner periphery 106 of each base member 106 could have a shape other than semi-annular, such as semi-square. When the two base members 103 of the two pieces 102 of the brush holder 100 are mated, their inner peripheries 106 form a central opening in which the commutator 30 is disposed when the power tool 10 is fully assembled.

Each base member 103 includes a first end surface 108 and a second end surface 110 disposed diametrically along a mating line X. Retention features are provided at the first end surfaces 108 and the second end surfaces 110 for holding the base members 103 together. The retention features may include a pin 112 extending perpendicularly from each of the first end surfaces 108 in a tangential direction of the central opening of the brush holder and a socket 114 recessed from each of the second end surfaces 110. These retention features may illustratively be integrally formed as part of the base members 103, such as by molding the base members 103 and associated retention features of a moldable material such as plastic, or the retention features may be separate components and affixed to the base members 103 in conventional fashion, such as by adhesive. When the base members 103 are joined, the first end surface 108 of one of the base members 103 contacts the second end surface 110 of the other one of the base members 103 and the pins 112 are inserted into the corresponding sockets 114. It should be understood and appreciated that the retention features can be any fastening means known in the art.

The brush boxes 104 can be made of conductive material, such as brass or steel, or of non-conductive material, depending on the desired durability and reliability of the brush box and whether it is desired that the brush boxes 104 be conductive or non-conductive. Brush box 104 includes a mounting portion 116, an arm 118 connected to the mounting portion 116 and extending perpendicularly from the base member 103, and a rectangular box portion 120. (It should be understood that portion 120 could have a cross-section other than rectangular, such as circular with the brush 104 having a corresponding cross-section.) The mounting portion 116 may illustratively be a plate placed on the base member 103. The mounting portion 116 includes a plurality of legs 122 for crimping to corresponding cutout portions 124 in the base member 103 to secure the mounting portion 116 to the base member 103.

The box portion 120 receives one of the brushes 105 therein. The box portion 120 is disposed in a middle portion of the base member 103 and is oriented so that a central axis of the box portion 120 extends in a radial direction of the base member 103. The box portion 120 has a first open end 126 adjacent to the inner periphery 106 of the base member 103 and a second open end 128 opposite to the first open end 126. Each brush 105 includes a lead wire (not shown) that is coupled to electrical power source 18 through a switch (not shown) of activation member 16.

The spring 101 may illustratively be a coil spring and includes one end connected to the arm 118 and the other end having a contact portion 132. The contact portion 132 is disposed adjacent to the second open end 128 of the box portion 120. When the brush 105 is received in the box portion 120, the contact portion 132 of the spring 101 contacts the brush 105 and urges the brush 105 radially inwardly against the commutator 30 to ensure that an electrical connection is established between the commutator 30 and the brush 105.

Referring to FIGS. 3 to 5, an assembly sequence to assemble power tool 10 using two-piece brush assembly 100 in accordance with an aspect of the present disclosure is described. Two-piece brush assembly 100 may illustratively received from a supplier with pieces 102 separated. Each piece 102 includes a brush box 104, a brush 105, and a spring 101 pre-assembled to the corresponding base members 103. The springs 101 and brushes 105 are in the unparked position so that they are in contact with the brushes 105.

A first one of the pieces 102 is inserted into a groove 133 in a first housing half 131 of the tool housing 12. The brush 105 is slidable inside the brush box 104 and the spring 101 is in contact with the brush 105 when the first piece 102 is disposed in groove 133.

Then, the motor 14 including the armature 40 and the commutator 30 is mounted in the first housing half 131 of power tool housing 12 with the commutator 30 located adjacent to the brush 105 of the first piece 102 of two-piece brush holder 100 as shown in FIG. 4. As the motor 14 is mounted, the commutator 30 pushes the brush 105 against the spring 101 so that the spring 101 is biased against brush 105. Because the commutator 30 is mounted to the first housing half 131 in an insertion direction Y (or mounting direction) parallel to the travel direction of the brush 105, the likelihood that brush 105 or brush box 104 will damage commutator 30 by brush 105 or brush box 104 is minimized during the insertion of motor 14 into housing half 131.

Thereafter, referring to FIG. 5, the second piece 102 of two-piece brush holder 100 is mated with the first piece 102 mounted in the first housing half 131 of power tool housing 12 so that the two-piece brush assembly holder 100 is now assembled to surround the commutator 30. The base members 102 are coupled through the engagement of the retention features, i.e., the pins 112 and the sockets 114. The other one of the base members 102 is mounted in the same insertion direction Y parallel to the travel direction of the brushes 62 until the pins 112 are completely received in the sockets 114. At the same time, the commutator 30 pushes the brush 105 carried by the other one of the base members 102 against the adjacent spring 101 so that the spring 101 is properly biased to apply the desired contact force on the brush 105.

Finally, a second half housing of the tool housing 12 is mounted to the first half housing. By using the bosses 134 and screws 136 (shown in FIG. 1), the first half housing and the second half housing are joined to enclose the motor 14.

The brush assembly 100 including two brush pieces 102 according to the present disclosure is advantageous in assembling the motor 14 in the tool housing 12. Instead of inserting the commutator 30 into the central opening of the brush holder, the separate base members 103 of the separate portions 102 are joined after the commutator 30 is positioned in place, thereby increasing the ease of assembling the brush holder around the commutator 30.

Moreover, because the commutator 30 is mounted in a direction parallel to the travel direction of the brushes 105, the likelihood of damaging the commutator 30 is reduced. Another advantage is that the springs 101 can be automatically biased to apply a desired contact force to the brushes after the assembly process is completed, thereby reducing the assembly time. The multi-portion structure allows for easy access to the brushes 105 and commutator 30 for services and replacement after the brush holder is assembled to the tool housing.

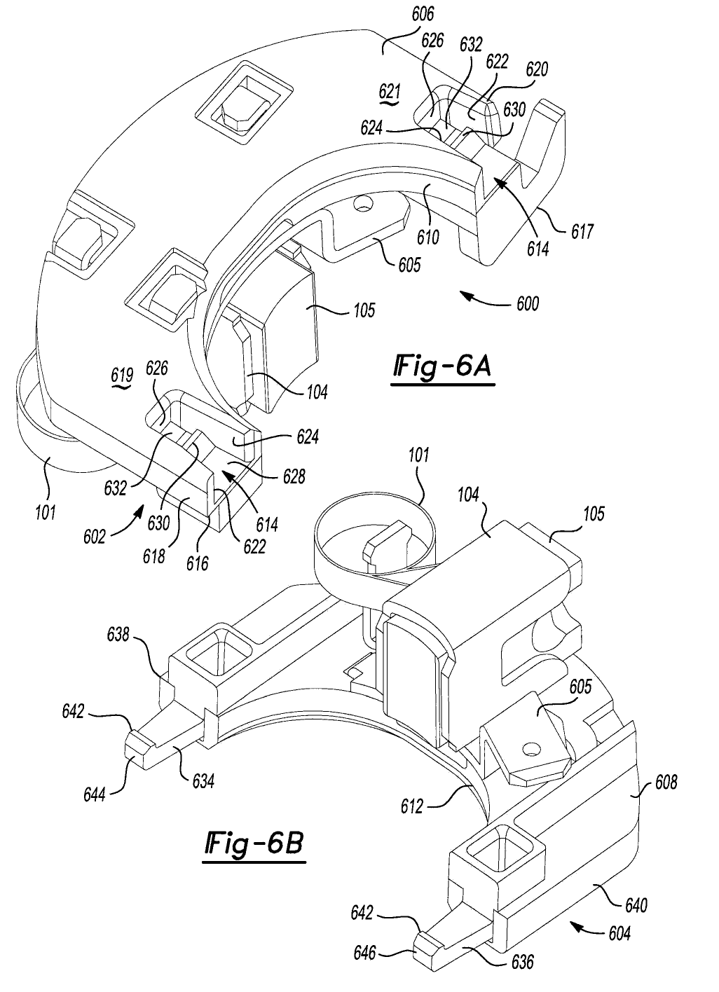

With reference to FIGS. 6A and 6B, another embodiment of a two-piece brush assembly 600 in accordance with an aspect of the present disclosure is described. Two-piece brush assembly 600 includes first and second pieces 602, 604. It should be understood that piece 604 is shown in FIG. 6B in an inverted position from when it is mated with piece 602.

Piece 602 includes a brush 1052 received in a brush box 104 mounted on a base member 606 and a spring 101 that urges the brush 105 against commutator 30. Piece 604 also includes a brush 105 received in a brush box 104 mounted on a base member 608 and a spring that urges brush 105 against commutator 30. Each brush box 104 includes a terminal 605 to which a respective lead wire (not shown) is connected when brush assembly 600 is assembled in a power tool, such as power tool 10. In an aspect, base members 606, 608 each have a semi-annular inner periphery 610, 612, respectively. It should be understood that the inner peripheries 610, 612 could have shapes other than semi-annular, such as semi-square. When the two base members 606, 608 are mated, their inner peripheries 610, 612 form a central opening in which the commutator 30 is disposed when the power tool is fully assembled.

Base member 606 includes recesses 614 in opposed sides 618, 620 at ends 616, 617 thereof. Each recess 614 is defined by opposed walls 622, 624, axial outer end 626 and bottom (as oriented in FIG. 6A) surface 628. Each recess provides an opening in an upper surface (as oriented in FIG. 6A) 619, 621 of each opposed side 618, 620. Each recess 614 has a detent 630 extending upwardly (as oriented in FIG. 6A) from bottom surface 628. Receptacles 632 are defined between each detent 622 and axial outer ends 628 of recesses 614.

Base member 608 includes legs 634 extending from opposed sides 638, 640. Each leg 634 includes a detent 642 at an end 644, 646, respectively, that extend upwardly (as oriented in FIG. 6B).

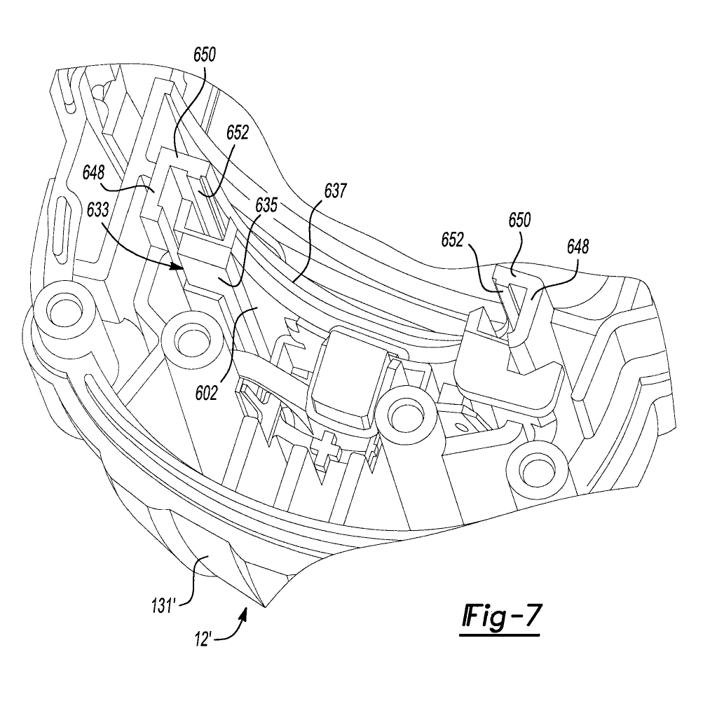

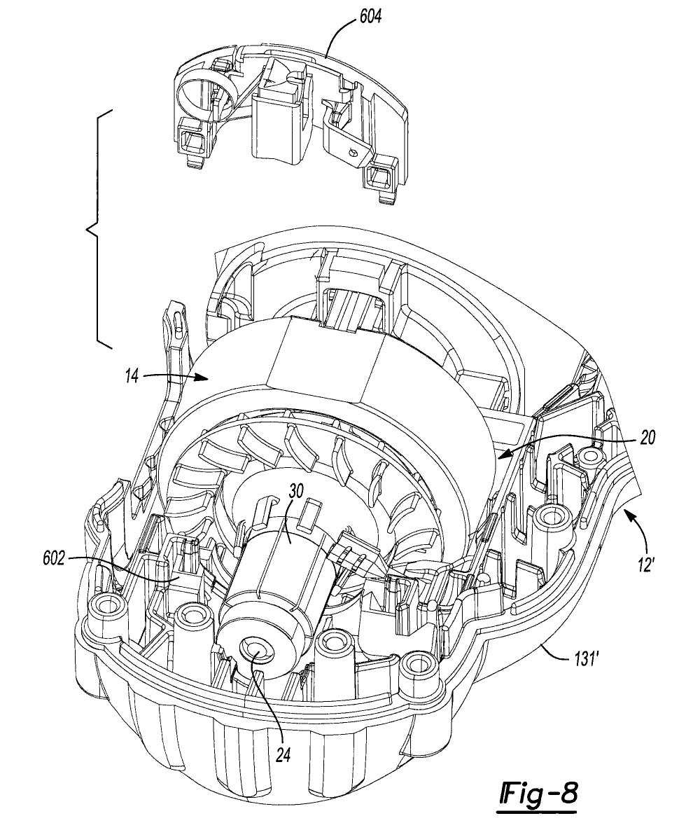

Referring to FIGS. 7 & 8, an assembly sequence to assemble a power tool, such as power tool 10, using two-piece brush assembly 600 in accordance with an aspect of the present disclosure is described. Brush assembly 600 may illustratively be received from a supplier with pieces 602, 604 separated and brushes 105 in the unparked position. Piece 602 is inserted into groove 633 in first housing half 131′ of the tool housing 12′. In this regard, groove 633 in housing half 131′ of power tool housing 12′ may differ from groove 133, as described below. The brush 105 is slidable inside the brush box 104 and the spring 101 is in contact with the brush 105 when the piece 602, 604 is disposed in groove 633.

Then, the motor 14 including the armature 22 and the commutator 30 is mounted in the first housing half 131 of power tool housing 12 with the commutator 30 located adjacent to the brush 105 of the piece 602, 604 of two-piece brush holder 100 as shown in FIG. 8. As the motor 14 is mounted, the commutator 30 pushes the brush 105 against the spring 101 so that the spring 101 is biased against brush 105. Because the commutator 30 is mounted to the first housing half 131′ in an insertion direction (or mounting direction) parallel to the travel direction of the brush 105, the likelihood that brush 105 or brush box 104 will damage commutator 30 by brush 105 or brush box 104 is minimized during the insertion of motor 14 into housing half 131′.

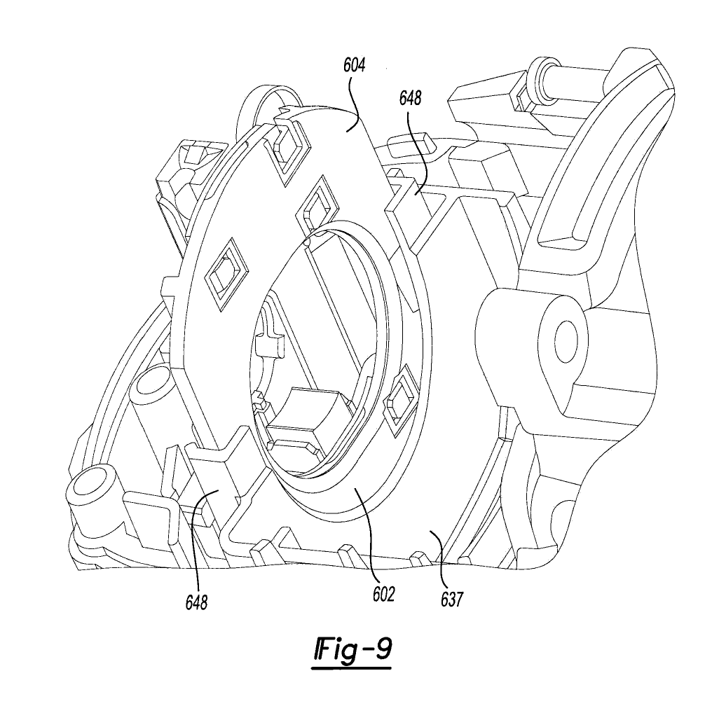

Piece 604 is then mated with the piece 602, 604 received in groove 633 of housing half 131′ of power tool housing 12′ as follows. Groove 633 is illustratively defined by opposed members 635, 637 which define the sides of groove 633. Member 637 includes opposed legs 648, illustratively L-shaped, extending upwardly (as oriented in FIGS. 7 & 8) on radially opposed sides of groove 633. Each radially inwardly extending portion 650 of each leg 648 may include an axially outwardly extending ridge 652 (as best shown in FIG. 7). Illustratively, when one piece 602 is received in the groove 633, opposed legs 648 extend beyond ends 616, 617 of piece 602. When piece 604 is mated with piece 602, legs 634 of piece 604 are inserted into recesses 614 of piece 602 with legs 634 disposed between ridges 652 of opposed legs 648 and the bottom surfaces 628 of recesses 614. Ridges 652 of opposed legs 648 urge legs 634 of piece 604 toward the bottom surfaces of recesses 614 so that detents 642 of legs 634 and detents 622 of recesses 614 snap together as piece 604 is pushed into groove 633, and held snapped to hold pieces 602, 604 together (as best shown in FIG. 9). Ridges 652 may illustratively be tapered, getting thicker as they go down opposed legs 648. Ridges 652 are sized to apply sufficient force to legs 634 of piece 604 so as to hold the detents 622 and 642 of pieces 602, 604 snapped together, but still allow piece 604 to be “unsnapped” from piece 602 without undue force. This allows for ease of disassembly of two-piece brush assembly from power tool 10 when brushes 62 need to be replaced.

It should be understood that opposed legs 648 may not have ridges 652, or member 637 may not have opposed legs 648. It should be understood that opposed members 635, 637 that define groove 633 are spaced so that the detents 622, 642 will snap together and be held snapped when second piece 602 is mated with first piece 604.

It should be understood that piece 604 could first be inserted in groove 633 and then piece 602 mated with piece 604 after motor 14 has been placed in first housing half 131′ of power tool housing 12.

While not shown in the figures, it should be appreciated that other features can be incorporated into the brush assembly without departing from the scope of the present disclosure. For example, the brush assembly may be provided with wire traps for providing strain relief. The base members and the tool housing may be provided with snap features therebetween to ensure proper engagement between the base members and the tool housing. Further, the base members may be provided with lockout features to ensure that the base members are assembled to the corresponding half portions of the tool housing.

The description of the present disclosure is merely exemplary in nature and, thus, variations that do not depart from the gist of the present disclosure are intended to be within the scope of the present disclosure. Such variations are not to be regarded as a departure from the spirit and scope of the present disclosure.

1. A power tool comprising:
a tool housing in which an electric motor is disposed, the electric motor including a stator and an armature rotatably received within the stator, the armature having an armature shaft on which a commutator is mounted; and
a brush assembly received in the tool housing and disposed around the commutator, the brush assembly including first and second pieces, each piece including a base member, each base member having a radially inner first surface and a radially inner second surface disposed on diametric diametrically of the brush holder, the first surface of one of the base members contacting the second surface of the other one of the base members, retention features provided at the first surfaces and the second surfaces that mate with each other and coact to secure the base members together, a brush box affixed to each base member, a brush received in the brush box, and a spring contacting the brush that urges the brush radially inwardly.

2. The power tool of claim 1, wherein the retention features include a pins and sockets.

3. The power tool of claim 2, wherein the pins are provided at the first surfaces and the sockets are provided at the second surfaces.

4. The power tool of claim 1, wherein each base member includes an arm extending perpendicularly from the base member to which the spring of the portion having that base member is attached.

5. The power tool of claim 1, wherein the housing includes grooves in which the base members are received.

6. A method of assembling a power tool, comprising:
pre-assembling first and second pieces of a brush assembly by pre-assembling a brush and a spring to a base member for each of the first and second pieces, each base member having mating features;
placing the first piece of the brush assembly in a first portion of a housing of the power tool;
placing a frameless electric motor having a stator, an armature affixed to an armature shaft to which a commutator is affixed in the first portion of the tool housing with the commutator adjacent the first piece of the brush assembly,
mating the second piece of the brush assembly to the first piece with the second piece of the brush assembly on a side of the commutator opposite the first piece of the brush assembly and mating the mating features of the base members together and securing the base members together by the mating features coating with each other; and
mating a second portion of the tool housing to the first portion of the tool housing.

7. The method of claim 6, wherein placing the first piece of the brush assembly in the first portion of the tool housing includes inserting the base member of the first piece into a groove of the first portion of the tool housing.

8. The method of claim 6, wherein placing the frameless electric motor in the first portion of the tool housing includes placing it so that during placement the commutator moves in a direction parallel to a travel direction of the brush of the first portion of the brush assembly.

9. A power tool comprising:
a tool housing in which an electric motor is disposed, the electric motor including a stator and an armature rotatably received within the stator, the armature having an armature shaft on which a commutator is mounted; and
a brush assembly received in the tool housing and disposed around the commutator, the brush assembly including first and second pieces received in a groove in the tool housing defined by opposed members, the first piece having a base member having opposed sides with a recess therein at ends of the opposed sides, the recess having a detent extending upwardly from a bottom surface, the second piece having opposed legs with each leg having a detent extending upwardly at an end, the opposed members that define the groove spaced so that the detents of the base members of the first and second pieces snap together and are held snapped together to secure the first and second pieces together, each of the first and second pieces having a brush box affixed to their respective base members, each of the first and second pieces having a brush received in their brush box and a spring that urges the brush against the commutator.

10. The power tool of claim 9, wherein the one of the opposed members that defines the groove includes opposed legs extending beyond the ends of the first piece when the first piece is received in the groove, the legs including ridges that urge the legs of second piece into the recesses of the first pieces.

11. The power tool of claim 9 where the opposed members that define the groove are spaced so that the second piece can be unsnapped from the first piece.

12. A method of assembling a power tool, comprising:
pre-assembling first and second pieces of a brush assembly by pre-assembling a brush and a spring to a base member for each of the first and second portions, the first piece having a base member having opposed sides with a recess therein at ends of the opposed sides, the recess having a detent extending upwardly from a bottom surface, the second piece having opposed legs with each leg having a detent extending upwardly at an end;
placing the first piece of the brush assembly in a groove in a first portion of a housing of the power tool defined by opposed members;
placing a frameless electric motor having a stator, an armature affixed to an armature shaft to which a commutator is affixed in the first portion of the tool housing with the commutator adjacent the first portion of the brush assembly,
mating the second portion of the brush assembly to the first portion with the second portion of the brush assembly on a side of the commutator opposite the first portion of the brush assembly by inserting the legs of the second piece in the groove between one of the opposed members that defines the groove and the first piece and urging the legs of the second piece in to the recesses of the first piece so that the detents snap together and holding the detents of the first and second pieces snapped together with the opposed members; and
mating a second portion of the tool housing to the first portion of the tool housing.

13. The method of claim 12, wherein placing the frameless electric motor in the first portion of the tool housing includes placing it so that during placement the commutator moves in a direction parallel to a travel direction of the brush of the first piece of the brush assembly.

14. The method of claim 12 including holding the detents of the first and second pieces together with the opposed members that define the groove with sufficient force to keep the detents snapped together but that allows the detents to be unsnapped to remove the second piece from the first piece.
